(19) United States
(12) Patent Application Publication
(10) Pub. No.: US 2018/0263372 A1
(43) Pub. Date: Sep. 20, 2018

(54) TRANSFORMABLE CHAIR

(71) Applicant: Scott Rohrer, Catonsville, MD (US)

(72) Inventor: Scott Rohrer, Catonsville, MD (US)

(21) Appl. No.: 15/923,602

(22) Filed: Mar. 16, 2018

Related U.S. Application Data
(60) Provisional application No. 62/472,087, filed on Mar. 16, 2017.

(51) Int. Cl. A47C 13/00; A47C 1/14; A47C 7/00; A47C 4/28; B62B 3/02

(52) U.S. Cl. CPC A47C 13/00; A47C 1/14; B62B 2206/006; A47C 4/28; B62B 3/02; A47C 7/006

(57) ABSTRACT

A transformable chair comprises a first portion comprising a seat, a second portion comprising a backrest, and a hinge mechanism connecting the first portion to the second portion and allowing the second portion to be rotated relative to the first portion. The transformable chair includes at least one space sized and shaped to store a bodyboard. In one version, the transformable chair can be unfolded into a flat configuration and folded into a cart configuration.

### PRIORITY

The present application claims the benefit of domestic priority based on U.S. Provisional Patent Application 62/472,087 filed on Mar. 16, 2017, the entirety of which is incorporated herein by reference.

### BACKGROUND

Spending a day at the beach can be one of life's great joys. However, the experience can often be anything but relaxing. Having to sit directly on hot or wet sand can be uncomfortable and having to deal with a sandy towel can be frustrating.

People often carry chairs to the beach to lift themselves up from the sand. In addition, a variety of other items are usually brought when going to the beach, such as umbrellas, coolers, and other accessories. Transporting these items from a car or hotel to and from the beach can be an annoyance. Furthermore, it is often desirable to have a safety floatation device when swimming and/or to have water accessories such as bodyboards to add to the enjoyment of the water. However, these are additional items that must be carried to the beach. It may also be desirable to carry items such as books, sunscreen, and personal belongings for a day at the beach. Carrying all of these items can be an inconvenience that keeps the experience from being as enjoyable as it could be.

Therefore, there is a need for a chair that can be easily transported and set up at a beach or other location. There is also a need for a chair that can assist in the transport and storage of additional items. In addition, there is a need for a chair that can transform into additional configurations.

### SUMMARY

The present invention satisfies these needs. In one aspect of the invention, a transformable chair is provided that is easily transportable.

In another aspect of the invention, a transformable chair transforms into a configuration where it can assist in transporting and/or storing additional items.

In another aspect of the invention, a transformable chair transforms into a flat configuration.

In another aspect of the invention, a transformable chair transforms into a flat configuration and transforms into a configuration where it can assist in transporting and/or storing additional items.

In another aspect of the invention, a transformable chair comprises a first portion comprising a seat, a second portion comprising a backrest, and a hinge mechanism connecting the first portion to the second portion and allowing the second portion to be rotated relative to the first portion, wherein the transformable chair includes a space sized and shaped to store a bodyboard.

In another aspect of the invention, a transformable chair comprises a first portion comprising a seat, a second portion comprising a backrest, and a hinge mechanism connecting the first portion to the second portion and allowing the second portion to be rotated relative to the first portion, wherein the transformable chair includes a space sized and shaped to store a bodyboard, wherein the first portion comprises a frame and a plurality of legs that are pivotable relative to the frame, wherein the second portion comprises one or more wheels, and wherein when the hinge mechanism 115 is rotated to where the angle between the seat and the backrest is less than 10 degrees, the transformable chair can be flipped over so that it forms a cart that can be rolled on the one or more wheels.

In another aspect of the invention, a transformable chair comprises a first portion comprising a U-shaped frame with a seat covering at least a portion of the top of the U-shaped frame, a second portion comprising a U-shaped frame with a backrest covering at least a portion of the top of the U-shaped frame, and a hinge mechanism connecting the first portion to the second portion and allowing the second portion to be rotated relative to the first portion, wherein the hinge mechanism can be locked in one or more backrest positions.

In another aspect of the invention, a transformable chair comprises a first portion comprising a U-shaped frame with a seat covering at least a portion of the top of the U-shaped frame, a second portion comprising a U-shaped frame with a backrest covering at least a portion of the top of the U-shaped frame, and a hinge mechanism connecting the first portion to the second portion and allowing the second portion to be rotated relative to the first portion, wherein the hinge mechanism can be locked in one or more backrest positions, wherein the U-shaped frames are sized and shaped to store a bodyboard therein.

In another aspect of the invention, a transformable chair comprises a first portion comprising a seat and one or more legs, a second portion comprising a backrest and one or more wheels, and a hinge mechanism connecting the first portion to the second portion and allowing the second portion to be rotated relative to the first portion, wherein the second portion can be rotated relative to the first portion to a position where the transformable chair is in a sitting configuration and to a position where the transformable chair is in a cart configuration where the seat and the backrest are folded onto one another and wherein the one or more legs extend upwardly.

In another aspect of the invention, a method comprises easily transporting a transformable chair.

In another aspect of the invention, a method comprises transforming a chair into a configuration where it can assist in transporting and/or storing additional items.

In another aspect of the invention, a method comprises transforming a chair into a flat configuration.

In another aspect of the invention, a method comprises transforming a chair into a flat configuration and transforming the chair into a configuration where it can assist in transporting and/or storing additional items.

In another aspect of the invention, a method comprises providing a transformable chair that comprises a first portion comprising a seat, a second portion comprising a backrest, and a hinge mechanism connecting the first portion to the second portion and allowing the second portion to be rotated relative to the first portion, and storing a bodyboard in a space in the transformable chair sized and shaped to store a bodyboard.

In another aspect of the invention, a method comprises providing a transformable chair that comprises a first portion comprising a U-shaped frame with a seat covering at least a portion of the top of the U-shaped frame, a second portion comprising a U-shaped frame with a backrest covering at least a portion of the top of the U-shaped frame, and a hinge mechanism connecting the first portion to the second portion and allowing the second portion to be rotated relative to the first portion, wherein the hinge mechanism can be locked in one or more backrest positions.

In another aspect of the invention, a method comprises providing a transformable chair that comprises a first portion comprising a seat and one or more legs, a second portion comprising a backrest and one or more wheels, and a hinge mechanism connecting the first portion to the second portion and allowing the second portion to be rotated relative to the first portion; and transforming the transformable chair from a sitting configuration to a cart configuration.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic side view of a transformable chair according to one version of the invention in a sitting configuration;

FIG. 2 is a schematic perspective view of the transformable chair of FIG. 1;

FIG. 3 is a schematic perspective view of the transformable chair of FIG. 1 from a different angle;

FIG. 4 is a schematic perspective view of a transformable chair according to one version of the invention in a flat configuration;

FIG. 5 is a schematic perspective view of a transformable chair according to one version of the invention in a folded configuration;

FIG. 6 is a schematic perspective view of a transformable chair according to one version of the invention in a carrying configuration;

FIG. 7A is a schematic rear view of a transformable chair according to one version of the invention in a cart configuration;

FIG. 7B is a schematic rear perspective view of a transformable chair according to one version of the invention in a cart configuration; and

FIG. 8 is a schematic rear perspective view of another version of a transformable chair according to one version of the invention in a cart configuration.

### DESCRIPTION

The present invention relates to a transformable chair. In particular, the invention relates to a transformable chair that transforms into multiple configurations. Although the invention is illustrated and described in the context of being useful for a beach chair, the present invention can be used in other ways, as would be readily apparent to those of ordinary skill in the art. Accordingly, the present invention should not be limited just to the examples and embodiments described herein.

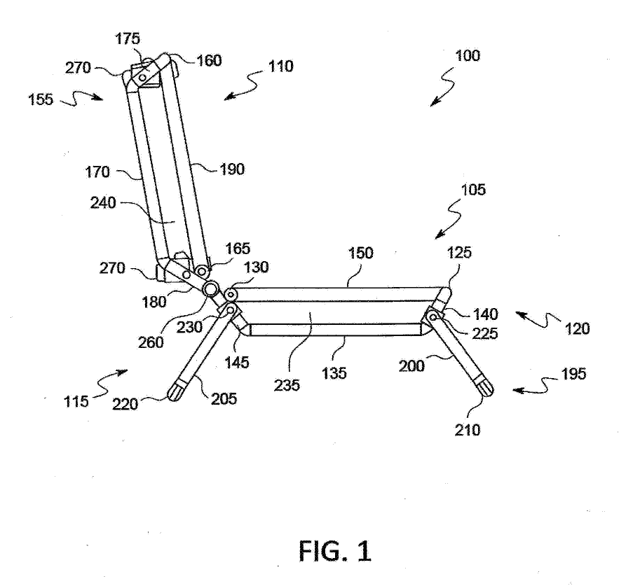

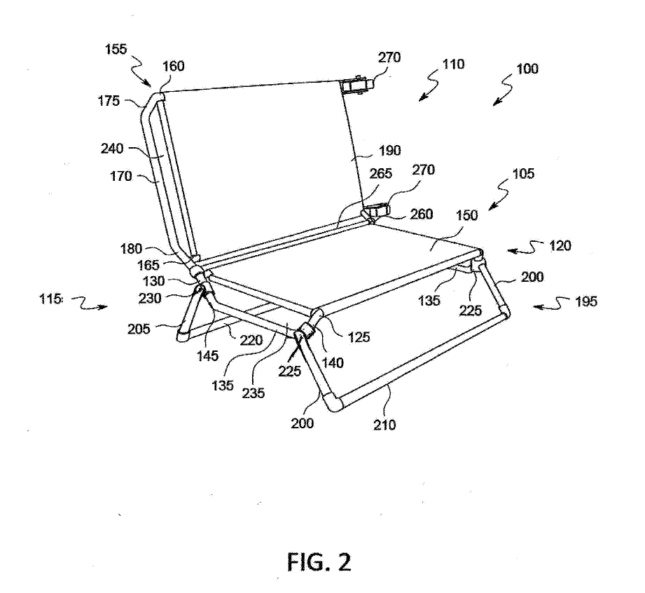

FIGS. 1 and 2 illustrate a transformable chair 100 according to a version of the invention. The transformable chair 100 includes a first portion 105 and a second portion 110. The first portion 105 and the second portion are connected to one another at a hinge mechanism 115 that allows the first portion 105 and the second portion 110 to rotate relative to one another. In FIGS. 1 and 2, the transformable chair 100 is shown in a sitting configuration. In this configuration, the first portion 105 serves as a seat and the second portion serves as a backrest. The hinge mechanism 115 is lockable in various positions so that the second portion 110 can be locked in a backrest position, such as the one shown in FIGS. 1 and 2, and can support the weight of a user's back when the user sits on the first portion 105. In one particular version, the second portion 110 is lockable in multiple backrest positions so the user can select a desire amount of recline. In the version of FIGS. 1 and 2, the transformable chair 100 is sized so that it can comfortably accommodate one or two people.

As can be in FIGS. 1 and 2, the first portion 105 includes a first frame 120. The first frame 120 is composed of a front bar 125 and a parallel back bar 130 that each extend most of the length of the transformable chair 100. The front bar 125 and back bar 130 extend in a direction parallel to the axis of rotation of the hinge mechanism 115. Extending perpendicularly to the front bar 125 and the back bar 130 are two cross bars 135 each located at different ends of the transformable chair 100. Each cross bar 135 is connected to the front bar 125 by a front connecting bar 140 and is connected to the back bar 130 by a back connecting bar 145. The front connecting bar 140 and the back connecting bar 145 extend downward from the front bar 125 and back bar 130 so that the cross bars 135 are offset from the front bar 125 and the back bar 130. Thus, as can be seen in FIGS. 1 and 2, the cross bars 135 define a plane that is spaced from and substantially parallel to a plane defined by the front bar 125 and the back bar 130.

The first frame 120 can be used to support a first panel 150 that forms a seat for the transformable chair 100. The first panel 150 can be composed of fabric, such as one or more of polyester, 600 denier polyester, 1200 denier polyester, cordura, vinyl, and nylon, and can serve as a seat for one or more users when the transformable chair 100 is in the sitting configuration of FIGS. 1 and 2. The first panel 150 is positionable on and/or around the front bar 125 and the back bar 130 in a manner that forms a seat surface between the front bar 125 and the back bar 130. In one version, such as the one shown in FIG. 1, the first panel 150 is made up of two layers of fabric connected along their longitudinally extending sides, and the first panel 150 is slid over the front bar 125 and the back bar 130 like a pillow case is slid over a pillow. In another version, the first panel 150 can be made up of one or more sheets of fabric and can have two longitudinally extending sleeves that each receive the front bar 125 and the back bar 130, respectively. In another version, the first panel can be a rigid piece of plastic or other material that is connected to the front bar 125 and the back bar 130. In yet another version, side bars can be provided that extend between and perpendicular to the front bar 125 and the back bar 130 and that are in the plane defined by the front bar 125 and the back bar 130 to give the first panel 150 more structural support.

As can also be in FIGS. 1 and 2, the second portion 110 includes a second frame 155. In the version shown, the second frame 155 is similar to but the mirror opposite of first frame 120. The second frame 110 includes a top bar 160, a lower bar 165, and two second frame cross bars 170. The second frame cross bars 170 are connected to the top bar 160 by connecting bars 175 and to the lower bar 165 by connecting bars 180. As in the first frame 120, the second frame cross bars 170 are offset from the top bar 160 and the lower bar 165 by the connecting bars 175, 180. The second frame cross bars 170 are parallel to one another and define a plane that is generally parallel to and offset from a plane defined by the top bar 160 and the lower bar 165. A second panel 190 of construction and composition similar to the first panel 150 is positionable on and/or around the top bar 160 and the lower bar 165 to form the backrest when the transformable chair 100 is in the sitting configuration. As with the first frame 120, side bars can be provided with the second frame 155 when desired.

The first frame 120 and/or the second frame can be U-shaped, as shown in FIGS. 1 and 2. The term U-shaped is intended to include frames that are V-shaped, partially square, rectangular, or other polygon, such as the partially trapezoidal shape shown in FIG. 1. The top of the U-shaped frame can be open, covered by a panel, or topped by another bar. The U-shaped frame is rotatable so that it is not necessarily an upright U. Thus, the “top” of the U-shaped frame may at times be located at the bottom or side of the frame. For example, the “top” of the second frame 155 in FIG. 1 is located on the right side of the frame. In the version shown in FIGS. 1 and 2, at least a portion of the tops of the U-shaped frames are covered by a panel to form the seat and/or backrest and opposed ends of the frames are open. The bars that make up the first frame 120 and the second frame 155 can be circular or any other geometrical shape in cross-section and can be made of any hard material, such as metal or plastic. In one particular version, the bars are cylindrical bars comprise aluminum and/or steel and have an outer diameter of from about 0.5 inches to about 1.5 inches or from about 0.75 inches to about 1 inch. The size and shape will vary depending on the material and the desired level of strength.

The first portion 105 of the transformable chair 100 can also be equipped with legs 195 that support the transformable chair 100 when in the sitting configuration as shown in FIGS. 1 and 2. The legs 195 include a pair of front leg bars 200 and a pair of back leg bars 205. The front leg bars 200 can optionally be connected to one another by a longitudinally extending front support bar 210. The back leg bars 205 can optionally be connected to one another by a longitudinally extending back support bar 220. The front leg bars 200 are connected to the front connecting bar 140 or to another portion of the first frame 120. The back leg bars 205 are connected to the back connecting bar 145 or to another portion of the first frame 120. In one version, the front leg bars 200 are connected to the first frame 120 at a front pivot 225 and the back leg bars 205 are connected to the first frame 120 at a back pivot 230. The front pivot 225 and the back pivot 230 allow the front leg bars 200 and the back leg bars 205 to rotate relative to the first frame 120. For example, in the version shown, the front leg bars 200 and the back leg bars 205 can rotate relative to the first frame about parallel axis that are parallel to the axis of rotation of the hinge mechanism 115. In addition, the front pivot 225 and the back pivot 230 can be lockable so that the legs can be locked in a position, such as the sitting position shown in FIGS. 1 and 2 when the transformable chair 100 is in the sitting configuration.

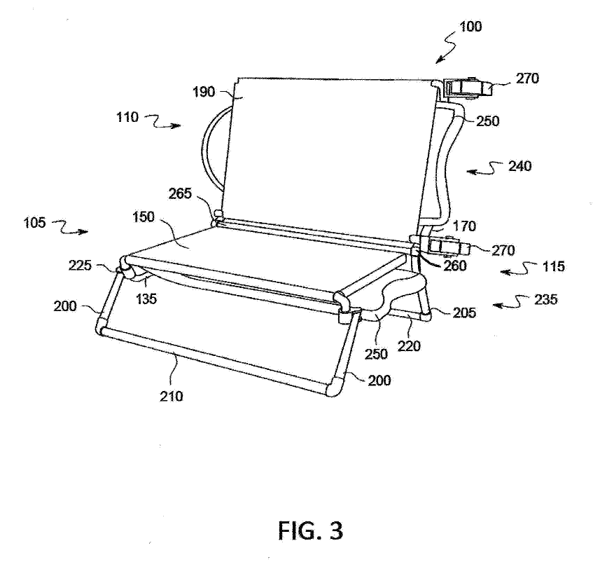

The shape of the first frame 120 and/or the second frame 155 creates a storage space within the frames. As can be seen in FIGS. 1 and 2, the offset of the cross bars 135 from the plane of the front bar 125 and back bar 130 creates a first frame space 235 into which an object can be inserted. Similarly, the top frame 155 includes a second frame space 240 formed by the offset of the second portion cross bars 170 from the top bar 160 and lower bar 165. In one particular version, as illustrated in FIG. 3, the first frame space 235 and/or the second frame space 240 can be sized and shaped to store a bodyboard 250. Bodyboards are like surfboards but are traditionally shorter and are designed for body surfing and other water activities. Bodyboards, which include boogie boards have a foam core and often a plastic bottom. Bodyboards are typically from about 33 inches to about 46 inches in length, from about 17 inches to about 21 inches, and from about 1 inch to 2 inches in height. Accordingly, the spaces 235, 240 in this version are dimensioned to accommodate this range of bodyboard sizes. The bodyboard 250 can be secured within the spaces 235, 240 by sizing the spaces so that he bodyboard 250 is slightly squeezed to keep it from sliding out. Optionally, a Velcro strap or the like can be provided to secure the bodyboard. In one version, first frame 120 and/or the second frame 155 have a length in the direction of the axis of rotation of the hinge mechanism 115 of from about 25 inches to about 40 inches, more preferably from about 30 inches to about 38 inches, and more preferably from about 32 inches to about 35 inches. The width of the frames can be from about 15 inches to about 25 inches, more preferably from about 18 inches to about 22 inches. The height of the interior of the frames can be from about 1.5 inches to about 4 inches, more preferably about 2 inches. The transformable chair 100 can come with one or more bodyboards 250 or the bodyboards can come separately.

In use, the transformable chair 100 can provide a portable seat that can accommodate one, two, or more individuals. The transformable chair 100 can be used at any venue where it is desirable to have a place to sit. The transformable chair 100 is particularly useful when being used at or near water activities. For example, the transformable chair 100 can be used at a beach, a lake, a river, a pool, a waterpark, and/or on a boat. The transformable chair 100 combines the comfort of a chair and the convenient of being able to store one or more bodyboards or like. The transformable chair 100 can be used as a chair with the bodyboards 250 removed, as shown in FIG. 2, or with the bodyboards 250 stowed, as shown in FIG. 3. In the version of FIGS. 1 and 2, the transformable chair 100 in the sitting configuration forms a bench-like seating structure where the length of the panel 150 that form the seat being greater than its width. The length extends along a direction the same as the axis of rotation of the hinge mechanism 115.

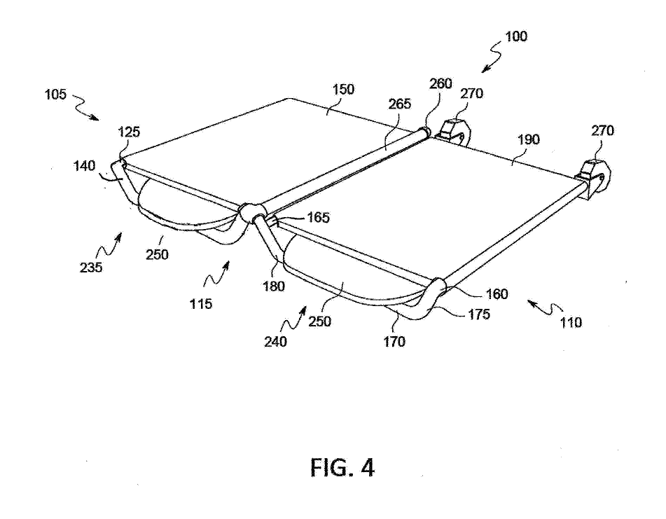

In one version, the transformable chair 100 provides even more transformative options. For example, as shown in FIG. 4, the transformable chair 100 can open up into a flat configuration. In this version, the hinge mechanism 115 includes a lockable hinge 260 on each end of the transformable chair 100 that allows the second portion 110 to rotate relative to the first portion 105 to a position where the first panel 150 and the second panel 190 are substantially planar or wherein the plane formed by the front bar 125 and the back bar 130 of the first portion 105 and the plane formed by the top bar 160 and lower bar 165 of the second portion 110 are angled relative to one another by from about 170 degrees to about 190 degrees, most preferably about 180 degrees. In like manner, the panel 150 that forms the seat and the panel 190 that forms the backrest are substantially planar and/or are at an angle of from about 170 degrees to about 190 degrees, most preferably about 180 degrees. The lockable hinges 260 are lockable in the flat configuration in addition to being lockable in at least one sitting configuration. In another version, the lockable hinges 260 are lockable in two or more sitting configurations, each having a different recline angle. Each lockable hinge 260 is thus rotatable by at least 90 degrees. In the flat configuration, the transformable chair 100 can be used to provide a flat surface that can rest on the sand or other surface to provide a flat platform when desired. One or more individuals can use this position to lie down while being slightly elevated off the sand at the beach. Note that the legs 195 are not shown in FIG. 4 for clarity.

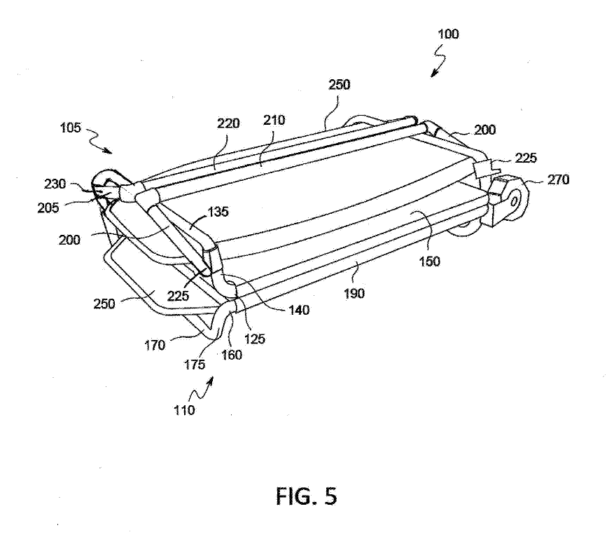

In another version, as shown in FIG. 5, the lockable hinges 260 allows for rotation in the opposite direction of that of FIG. 4 to cause the second portion 110 to be folded on top of the first portion 105 into a folded configuration of the transformable chair 100. In this version, the lockable hinges 260 can rotate at least about 140 degrees to allow the second portion 110 to be locked at one or more sitting configurations and to be folded into the folded configuration. In the folded configuration the panel 150 that forms the seat and/or the plane formed by the top of the first frame 120 and the backrest and/or the plane formed by the top of the second frame 155 are angled relative to one another by less than 10 degrees, more preferably about 0 degrees. In yet another version, the lockable hinges 260 allow for at least 180 degrees of rotation so that the transformable chair 100 can be positioned in the flat configuration, the sitting configuration, and in the folded configuration. The lockable hinges 260 can be locked in any manner known in the art in these configurations with there preferably being multiple sitting positions available.

As shown in FIG. 5, in one version, the transformable chair 100 can be transported by rolling. After the second section 110 is folded onto the first portion 105 so that the transformable chair 100 is in the folded configuration, the transformable chair 100 can be flipped over so that the second portion 110 is below the first portion 105. The legs 195 can also be rotated by pivots 225 and 230 so that he front leg bars 200 and the back leg bars 205 are conveniently folded and out of the way. A pair of wheels 270 is provided that are attached to the second frame 155 as shown in FIGS. 3 and 5. The transformable chair 100 can then be lifted at the end opposite the end with the wheels 270, such as by lifting cross bar 170 opposite the wheels 270. The transformable chair 100 can then be pulled and rolled on its wheels 270 in similar manner to a wheeled piece of luggage. Optionally a handle can be provided on the second frame 110. In one version, the handle can be telescopically extendable. The transformable chair 100 can be rolled with either the bodyboards 250 stowed in the spaces 235, 240 or without the bodyboards stowed. In another version, the one or more wheels 270 can be provided on the first frame 105. In this version, the one or more wheels 270 are of sufficient large diameter to lift the legs 195 off the ground when folded and sufficiently small to not touch the ground when the transformable chair 100 is in the sitting configuration.

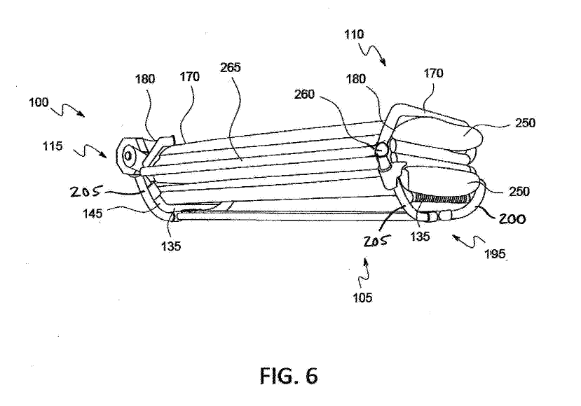

FIG. 6 illustrates another manner of transporting the transformable chair 100. In this version, a hinge bar 265 connects the two lockable hinges 260 and extends longitudinally from one end of the transformable chair 100 to the other. The hinge bar 265 is graspable and can be used by one or more individuals to lift and carry the transformable chair 100. Optionally, a strap can be attached to the hinge bar 265 to allow the transformable chair 100 to be carried over an individual's shoulder or on an individual's back. In another version, the hinge bar 265 can be removed and a strap can be attached to one of the frames on each end of the transformable chair 100. Also shown in FIG. 6 is another version of the front leg bars 200 and back leg bars 205. As can been seen, these bars can be curved or otherwise shaped so as to more closely conform to the contour of a bodyboard 250 when it is inserted into the first portion 105.

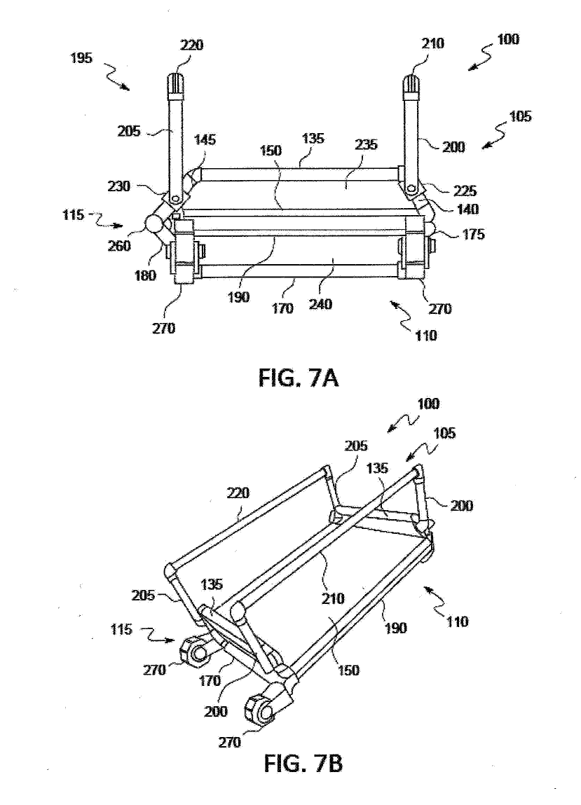

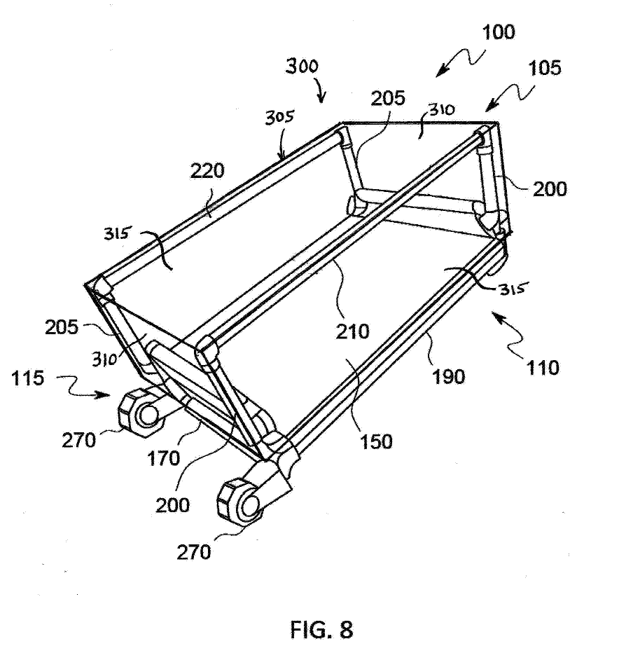

In another version, the transformable chair 100 can be placed in a cart configuration, as shown in FIGS. 7A and 7B. The cart configuration is similar to the folded configuration of FIG. 5 except that the legs 195 are locked in an upright position by rotating them at the pivots 225, 230 and locking them. In the cart configuration, the transformable chair 100 can be used to store additional items between the upright legs 195. As shown in FIG. 8, the legs 195 can be provided with sidewalls 300 that are attachable to the legs 195 and the create an at least partially enclosed space within the legs 195. The sidewalls 300 can be permanent or removable and can be rigid or flexible. In one version, as shown in FIG. 8, the sidewalls 300 are made of a netting 305 that is removably attachable to the legs 195, such as by being slidable over or around the legs 195. In the version shown, the netting 305 includes end walls 310 and front and back walls 315, all composed of a net, mesh, or fabric material. When not in use, the netting 305 can be stored in a pocket (not shown) provided on one of the panels 150, 190. In another version, the sidewalls can be made up of three walls with the end opposite the wheels being open. When the sidewalls 300 are installed and the transformable chair 100 is in the cart position, additional items can be carried in the cart, such as towels, sunscreen, clothing, flippers, books, a beach bag, cooler, food, additional small chairs, or the like.

The transformable chair 100 of the invention can include any combination of the above described features. In one version, the transformable chair includes all or most of the above features. When this version is in use at the beach, a user can use the transformable chair 100 in its cart configuration to transport the transformable chair 100, one or more bodyboards 250, and additional items to a spot on the beach. The user can then remove items from between the legs 195, remove the netting 305 from the legs, and rotate the legs 195 to their sitting position. The user would then flip the transformable chair 100 so that he legs 195 are positioned on the sand or ground and rotate the second portion 110 relative to the first portion 105 by rotating the hinge mechanism 115 until the second portion is locked in a backrest position and the transformable chair 100 is in a sitting configuration. The bodyboards 250 can be left in the transformable chair 100 or removed and used in the water. The user can also have the option of opening the transformable chair 100 to the flat configuration by continuing to rotate the second portion 110 relative to the first portion 105 until the portions are substantially planar and then folding the legs 195 into their folded position like the legs 195 are shown in FIG. 5. A reversal of the operations will return the transformable chair 100 its cart configuration and the transformable chair 100 can be used to easily transport the transformable chair 100 and additional items away from the beach or other location.

In this version, the hinge mechanism 115 and the legs 195 allow for positioning and locking at multiple positions. The hinge mechanism is lockable so that the second portion 110 is locked at an angle relative to the first portion 105 of about 180 degrees, at one or more angles ranging from about 140 degrees to about 90 degrees, and at an angle of about 0 degrees. Preferably, the hinge mechanism will be lockable at multiple backrest positions when in the sitting configuration. For example, the hinge mechanism 115 can be lockable at an angle of the second portion 110 relative to the first portion 115 of from about 140 degrees to about 130 degrees and from about 100 degrees to about 90 degrees. In another version, the hinge mechanism 115 does not lock at the 0 degrees position. In one specific version, the hinge mechanism 115 includes a locking mechanism that makes the hinge mechanism lockable at any angle between 0 degrees and 180 degrees. In yet another version, the hinge mechanism 115 is rotatable about 360 degrees. When discussing the relative angles of the first portion 105 and the second portion 110, the angles can be between the plane formed by the front bar 125 and back bar 130 and the plane formed by the top bar 160 and the lower bar 65; between the top of the first U-shaped frame 120 and the top of the second U-shaped frame 155; between the panel 150 that forms the seat and the panel 190 that forms the backrest; and/or between the first cross bars 135 and the second cross bars 170.

The legs 195 are also lockable at their pivots 225, 230 at multiple positions. For example, the legs 195 can be locked and/or positioned so they are at an angle relative to the cross bars 135 of from about 90 degrees to about 140 degrees, of about 90 degrees, and optionally in their folded position. In one specific version, the legs 195 are lockable and/or positionable at a range of angles from about 0 degrees to about 140 degrees. In yet another version, the pivots 225, 230 are not lockable. Instead, the rotation is prevented beyond an angle of from about 100 degrees to about 140 degrees. In this version, the legs 195 can be rotated outwardly to their greatest extent and be in the position shown in FIG. 1. Since the legs 195 cannot rotate beyond this point, they can support the weight of the transformable chair 100, whatever it is storing, and one or more users sitting on it. Also in this version, the pivots 225, 230 are also designed to have sufficient resistance that the legs will maintain themselves in the upright position when in the cart configuration and in the folded position when in the folded configuration.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

What is claimed is:

1. A transformable chair comprising:
a first portion comprising a seat;
a second portion comprising a backrest; and
a hinge mechanism connecting the first portion to the second portion and allowing the second portion to be rotated relative to the first portion,
wherein the transformable chair includes a space sized and shaped to store a bodyboard.

2. A transformable chair according to claim 1 wherein the second portion can be rotated relative to the first portion from a position where the angle between the seat and the backrest is from about 170 degrees to about 190 degree to a position where the angle between the seat and the backrest is less than 10 degrees.

3. A transformable chair according to claim 1 wherein the second portion can be rotated relative to the first portion to a position where the angle between the seat and the backrest is about 0 degrees.

4. A transformable chair according to claim 1 wherein the seat has a length extending in the direction of the axis of rotation of the hinge mechanism and a width, and wherein the length is greater than the width.

5. A transformable chair according to claim 1 wherein the seat or backrest is supported by a frame and wherein the frame includes the space where a bodyboard can be stored.

6. A transformable chair according to claim 1 wherein the seat and backrest are each supported by a frame and wherein both frames include a space where a bodyboard can be stored.

7. A transformable chair according to claim 1 wherein the first portion comprises a frame and a plurality of legs that are pivotable relative to the frame.

8. A transformable chair according to claim 1 wherein the first portion or the second portion comprises one or more wheels.

9. A transformable chair according to claim 1 wherein the first portion comprises a frame and a plurality of legs that are pivotable relative to the frame, wherein the second portion comprises one or more wheels, and wherein when the hinge mechanism is rotated to where the angle between the seat and the backrest is less than 10 degrees, the transformable chair can be flipped over so that it forms a cart that can be rolled on the one or more wheels.

10. A transformable chair comprising:
a first portion comprising a U-shaped frame with a seat covering at least a portion of the top of the U-shaped frame;
a second portion comprising a U-shaped frame with a backrest covering at least a portion of the top of the U-shaped frame; and
a hinge mechanism connecting the first portion to the second portion and allowing the second portion to be rotated relative to the first portion, wherein the hinge mechanism can be locked in one or more backrest positions.

11. A transformable chair according to claim 10 wherein the U-shaped frames are sized and shaped to store a bodyboard therein.

12. A transformable chair according to claim 10 wherein the seat or the backrest comprises a fabric or plastic panel.

13. A transformable chair according to claim 10 wherein the hinge mechanism is rotatable to a position where the transformable chair is in a flat configuration where the backrest and the seat are substantially planar.

14. A transformable chair according to claim 10 wherein the hinge mechanism is rotatable to a position where the transformable chair is in a folded configuration where the angle between the seat and the backrest is less than about 10 degrees.

15. A transformable chair according to claim 10 wherein the hinge mechanism is rotatable to a position wherein the transformable chair is in a folded configuration and wherein the second portion includes at least one wheel so the transformable chair can be flipped over and rolled on the at least one wheel.

16. A transformable chair according to claim 10 further comprising one or more legs that are pivotally attached to the U-shaped frame of the first portion.

17. A transformable chair comprising:
a first portion comprising a seat and one or more legs;
a second portion comprising a backrest and one or more wheels; and
a hinge mechanism connecting the first portion to the second portion and allowing the second portion to be rotated relative to the first portion,
wherein the second portion can be rotated relative to the first portion to a position where the transformable chair is in a sitting configuration and to a position where the transformable chair is in a cart configuration where the seat and the backrest are folded onto one another and wherein the one or more legs extend upwardly.

18. A transformable chair according to claim 17 further including one or more sidewalls that are attachable to the legs to create a storage area between the legs.

19. A transformable chair according to claim 18 wherein the one or more sidewalls is a netting that is removably attachable to the legs.
